(19) United States
(12) Patent Application Publication
(10) Pub. No.: US 2009/0250846 A1
(43) Pub. Date: Oct. 8, 2009

(54) PROCESS FOR THE MANUFACTURING OF A MULTILAYER HOLLOW BODY THAT INCLUDES AT LEAST ONE WELD

(75) Inventors: Bjorn Criel, Sint-Martens-Lennik (BE); Herve Lemoine, Tracy Le Mont (FR)

Correspondence Address: OBLON, SPIVAK, MCCLELLAND MAIER & NEUSTADT, P.C., 1940 DUKE STREET, ALEXANDRIA, VA, 22314, US

(73) Assignee: INERGY AUTO. SYSTEMS RESEARCH (SOCIETE ANONYME), Bruxelles (BE)

(21) Appl. No.: 11/721,775

(22) PCT Filed: Dec. 16, 2005
(86) PCT No.: PCT/EP2005/056880

§ 371 Date: Feb. 12, 2008

(30) Foreign Application Priority Data
Dec. 16, 2004 (FR) 04.13407

(51) Int. Cl. B29C 47/76; B29C 45/00

(52) U.S. Cl. 264/511; 264/513; 425/541

(57) ABSTRACT

A process for producing, by molding. a hollow plastic body with a multilayer structure including a liquid barrier layer. In the process: a) a parison including at least one part to be welded is inserted into an open mold including at least two impressions provided with a weld zone to position the part to be welded in the weld zone; b) the mold is closed, juxtaposing its impressions to clamp that part of the parison to be welded and to carry out welding; c) a pressurized fluid is injected into the mold and/or a vacuum is pulled behind the mold impressions to press the parison against the mold impressions and to mold the hollow body; and d) the mold is opened and the hollow body extracted During a) to d), the mold impressions are cooled, exception at the weld zone, which is heated at least during a) and b).

The present invention relates to a process for the manufacture of a multilayer hollow body that includes at least one weld.

Plastic-based multilayer hollow bodies have been developed in order to meet use needs which require properties that cannot be conferred by a single thermoplastic. In particular, this technique has been used when it is required to manufacture plastic hollow bodies having both a high rigidity at ordinary temperature and good impermeability to liquids and gases that they are intended to contain. In this case, the impermeabilization function is generally provided by a layer internal to the structure, of small thickness and of low mechanical strength, which is made of a material behaving as a barrier to the liquids and gases contained in the hollow body.

Plastic-based multilayer hollow bodies are generally obtained by moulding as a single component (blow-moulding or thermoforming of a single parison, which is clamped/welded in the mould, or of several parison portions that are welded directly in the mould) or by welding several separately moulded parts.

Moreover, there are requirements to substantially reduce the admissible amounts of vapour and liquid that escape into the environment from vessels containing organic substances. In the field of fuel tanks, new standards imposing extremely low limits of admissible losses will very soon come into force.

In the hollow bodies manufactured as described above by assembly of one or more welded multilayer elements, the impermeability of the weld zone is reduced, since the multilayer structure is crushed in the welding plane, which usually results in a folding of the layers of one element onto that of the welded element and the welding of the internal layer of each element with that of the other element. This generally results in a discontinuity in the barrier layer of the structure of the hollow body produced, therefore giving rise to a preferential path for vapour and liquid leaks.

In Application EP 1 190 837, the Applicant proposes to solve this problem by ensuring that, in the weld zone, the welded elements are extended towards the outside of the hollow body by a tapered appendage (one tapering down to a point where the barrier layers join up).

Now, in current blow-moulding or thermoforming processes, it is general practice to cool the impressions of the mould right from the start of moulding, so as to be able to increase the manufacturing rates. However, the Applicant has observed that this procedure generally results in welds of poor quality, in particular in the case of welds with a tapered bead as mentioned above.

The object of the present invention is therefore to provide a process for the manufacture of a multilayer hollow body that includes at least one weld, which makes it possible to achieve a high production rate without impairing the quality of the weld.

For this purpose, the invention relates to a process for the production, by moulding, of a hollow plastic body with a multilayer structure that includes a liquid barrier layer, the said process involving at least one welding operation and comprising the following steps:

a) a parison comprising at least one part to be welded is inserted into an open mould comprising at least two impressions that are provided with a weld zone so as to position the part to be welded in the weld zone;

b) the mould is closed, juxtaposing its impressions so as to clamp that part to be welded and to carry out the welding;

c) a pressurized fluid is injected into the mould and/or a vacuum is pulled behind the mould impressions in order to press the parison against the mould impressions and to mould the hollow body, and

d) the mould is opened and the hollow body extracted, and the said process being characterized in that, during steps a) to d), the mould impressions are cooled, with the exception of the weld zone, which is heated using a suitable device at least during steps a) and b).

The fact of heating the weld zone in its external part (the mould impressions) makes it possible to obtain a weld of better quality (which has less of a tendency to open).

Another advantage of heating the weld zone according to the invention consists of the fact that this makes it easier for the material in this zone to be squashed and therefore a thinner weld bead is obtained. This gives the bead better mechanical strength and makes it easier to demould the hollow body obtained. This demoulding may thus be carried out by hand and no longer with a knife liable to damage the weld bead (the appendage, as the case may be). This reduction in thickness, and the juxtaposition of the barrier layers that result therefrom, is also favourable from the impermeability standpoint (since the thickness of the leak path is reduced).

A final advantage of the present invention may be obtained by also heating the weld zone during low moulding and up to the point of demoulding the tank. By the use of a specific device, which will be described later, it is then easier to separate the scraps (the peripheral part of the parison, that constitutes manufacturing waste and is generally called the “sprue”) from the tank.

For a given clamping unit, the fact that the parting line is heated improves closure of the mould (ease of achieving complete mould closure). The ease of deflashing increases with the temperature of the mould in the weld zone.

The term “hollow body” is understood to mean a sealed tank capable of storing a fluid under a wide variety of different operating and environmental conditions. Examples of tanks that are very suitable are fuel tanks and in particular those that are fitted onto motor vehicles.

The hollow body according to the invention is made of plastic.

The term “plastic” denotes any material comprising at least one synthetic resin polymer.

All types of plastics may be suitable. Very suitable plastics fall within the category of thermoplastics.

The term “thermoplastic” denotes any thermoplastic polymer, including thermoplastic elastomers, as well as blends thereof. The term “polymer” denotes both homopolymers and copolymers (especially binary or ternary copolymers). Examples of such copolymers are, non-limitingly: random copolymers, linear block copolymers, other block copolymers, and graft copolymers.

Any type of thermoplastic polymer or copolymer, the melting point of which is below the decomposition temperature, is suitable. Thermoplastics having a melting range spread over at least 10 degrees Celsius are particularly suitable. Examples of such materials include those that exhibit polydispersion in their molecular weight.

In particular, polyolefins, thermoplastic polyesters, polyketones, polyamides and copolymers thereof maybe used. A blend of polymers or copolymers may also be used, as may a blend of polymeric materials with inorganic, organic and/or natural fillers such as, for example, but not limitingly: carbon, salts and other inorganic derivatives, and natural or polymeric fibres.

According to the invention, the hollow body is a multilayer structure consisting of stacked layers bonded together, comprising at least one layer based on at least one of the polymers or copolymers described above and a barrier layer. One polymer often employed for the non-barrier layer or layers is polyethylene. Excellent results have been obtained with high-density polyethylene (HDPE), in particular in the case of the abovementioned fuel tanks.

As regards the nature and the thickness of the barrier layer, these are chosen so as to minimize the permeability of liquids and gases in contact with the inner surface of the hollow body. In particular if the hollow body is a fuel tank, this layer is preferably based on a barrier resin, that is to say a fuel-impermeable resin, such as for example EVOH (a partially hydrolysed ethylene/vinyl acetate copolymer). This layer preferably lies within the polymeric multilayer structure and is consequently surrounded on both sides by at least one layer of a plastic not having barrier properties (preferably HDPE: see above). It is particularly advantageous, most especially in the case of fuel tanks, for the barrier layer to be based on EVOH and for it to be surrounded on both sides by at least one layer based on HDPE. In such a structure, an adhesive is generally placed between each of the abovementioned layers. This adhesive is advantageously modified HDPE (for example HDPE grafted with maleic anhydride or with a similar functional compound, giving it a certain compatibility with each of the neighbouring layers).

According to the invention, the parison from which the hollow body is moulded includes at least one part to be welded. By this it is generally meant that the body has a discontinuity (opening) that has to be closed up, that is to say its edges have to pinched together and welded.

This parison may consist of a substantially cylindrical single piece whose two ends constitute the parts to be welded (by flattening the cylinder by pinching together the two edges thus obtained, at each end, and welding them to each other). Alternatively, the parison may consist of at least two separate sheets, the edges of which constitute the part to be welded (the two sheets then being welded to each other around their perimeter). In this case, the sheets to be welded preferably have a similar structure. By this it is meant that the structure of each of the sheets comprises a number of layers not different from one another by more than three units, and preferably by not more than two units, and that the nature of the polymers involved in the corresponding layers on either side of the welding surface is compatible from the chemical standpoint and from the standpoint of its capability of being assembled by welding. A hollow body in which the sheets have structures with the same number of layers and, in particular, have identical structures is preferred.

In the case of a blow-moulded tank (in which a pressurized fluid is injected into the mould), the parison preferably consists of two separate “sheets” resulting from cutting one and the same extruded parison, as described in Application EP 1 110 697 in the name of the Applicant, the content of which application is for this purpose introduced by reference into the present application. According to this variant, after a single parison has been extruded, this is cut over its entire length along two diametrically opposed lines so as to obtain two separate parts (sheets). Such a procedure, unlike the blow-moulding of two separately extruded sheets, the thickness of which is constant, makes it possible to use parisons of variable thickness (that is to say a thickness that is not constant over its length) which are obtained by a suitable extrusion device (generally an extruder provided with a die fitted with a mandrel whose position can be adjusted). Such a parison takes account of the thickness reduction that occurs during blow-moulding at certain points on the parison as a result of the variable degrees of deformation of the material in the mould.

Preferably, the two-part parison is blow-moulded in a mould comprising two impressions (or external parts) and a core (or internal part) using a process similar to that described in Patent GB 1 410 215, the content of which for this purpose is introduced by reference into the present application. The core makes it possible in this variant to place components on the parison before the mould is closed. The term “core” is understood to mean a piece of appropriate size and shape for being able to be inserted into the mould impressions. Such a piece is for example described in Patent GB 1 410 215, the content of which for this purpose is introduced by reference into the present application. The core according to this variant of the invention may also be used to inject a pressurized gas into the mould in order to press the parison against the mould impressions. Finally, the core may also be used for at least partly monitoring the process. For this purpose, a camera may for example be incorporated into the core so as to see and check the quality of the fastening of the accessories by image analysis. One or more sensors for measuring one or more quantities, such as force, travel, pressure, temperature, may be fitted onto the core so as to better control the way in which the accessories are fastened.

Alternatively, the tank may be moulded by thermoforming two sheets (or by vacuum forming, by pulling a vacuum behind the mould impressions). Such a process generally results in little or no non-uniform thickness reductions and therefore can cater for a parison of constant thickness (for example extruded sheets). In practice one way of implementing this variant consists in keeping the sheets each in a frame that allows them to be placed on the mould impressions and to provide the seal (between the parison and the said impressions) necessary for pulling a vacuum. In the process according to this variant of the invention, a first vacuum forming (or preforming) may be carried out before the mould is closed and, by using a suitable gripping tool (robot arm), may be followed by the placement of accessories on the parison (or sheets). Of course, this placement of accessories is also done before the mould is closed.

The process according to the invention is characterized in that, during steps a) to d), the mould impressions are cooled over their entire internal surface with the exception of the weld zone, which is heated by a suitable device at least during steps a) and b). The term “internal surface” is understood to mean the surface intended to be in contact with the parison and the term “external surface” is understood to mean the surface on the opposite side from the first one (which is in general in contact with the ambient environment).

It should be noted that the weld zone could be heated throughout the process (i.e. during step c) and d) too).

One advantage of the latter variant consists of the fact that the deflashing operation (or the removal of the abovementioned sprue) may be carried out very easily, the heated zone constituting the actual transition between the tank and the said scraps. According to this variant, during demoulding all that is required is to use a specific tool for separating the tank from the sprue, profiting from the fact that the material in this zone has been softened. However, in this variant care must be taken not to damage the weld bead. A very suitable method therefore consists in folding the edges of the parison back over the outside of the mould impressions and to fasten them to just one of the two impressions. Thus, by taking care during demoulding to ensure that the tank itself remains attached to the other impression of the mould, the sprue is quickly and easily separated from the tank.

Another advantage of this variant lies in the ease with which the process according to the invention is carried out. This is because the heating can be maintained throughout, and not stopped and then restarted.

If the heating is cut off during steps c) and d), it is preferable to use a suitable device having a low thermal inertia (and therefore one that can heat up quickly). For this purpose, the mould parts in question can be heated by induction heating. These mould parts are then made of a special alloy so as to localize the heating therein.

Generally speaking, the mould impressions are cooled over their entire internal surface down to a temperature of between 0° C. and 20° C. during steps a) to d), but are heated in the weld zone to at least 40° C., preferably at least 60° C. or even at least 80° C. during steps a) and b).

In the abovementioned cases, in which the moulding takes place by a process involving the use of a core (blow-moulding) or of frames (thermoforming), these devices are preferably also heated at least during part of the process. In general, either a core or a robot arm is used to provide the parison with functional elements before it is moulded, especially for the placing of internal components (for example by riveting), for the compression moulding of certain elements (a duct, for example), etc. Within the context of the invention, such a process may comprise the following steps between steps a) and b):

a1) a core is inserted inside the parison located in the mould;

a2) the mould is closed a first time (with the impressions brought back around the core);

a3) the parison is pressed against the mould impressions (by blowing through the core and/or by vacuum suction behind the impressions);

a4) the parison is provided with functional elements by means of the core; and

a5) the mould is opened and the core removed.

Alternatively, when the parison consists of two sheets to be thermoformed, such a process may comprise the following steps before step b):

a1) the two sheets are fastened via their perimeter to two frames;

a2) the two frames are placed on the mould impressions so as to obtain a sealed zone between the sheets and the mould impressions;

a3) the sheets are pressed against the mould impressions by vacuum suction behind the impressions;

a4) optionally, the parison is provided with functional elements by means of a robot arm; and

a5) the frames are removed.

In each of the two variants, the actual parison forming operation (i.e. its deformation in order to give it substantially the shape of the tank) mainly takes place during step a3). During step c) (during which the abovementioned welding is carried out), the pressure (or vacuum) is maintained simply to ensure dimensional stability of the tank.

In these two variants of the process according to the invention, the heating of the weld zone (preferably both in its external part (the impressions) and its internal part (the core or frames)) must be activated during the phase in which the mould is closed on the core.

Whether or not the zones for heating the mould impressions are inactivated during certain phases of the process depends on the rate at which these zones can change temperature (which in particular depends on the nature of their constituent material), since it is absolutely necessary for the mould to be hot during the following manufacturing cycle.

The activation/deactivation of the core heating operation is easier to accomplish, and therefore can be optimized as explained above.

This is because the fact of heating the core (insert) when the mould has been closed up on itself prevents, during formation of the weld bead (when the mould is closed a second time in order to weld the parison and to mould the definitive hollow body), excessively large weld beads from being produced on the internal surface of the parison and of the hollow body resulting therefrom. In this variant, it should be understood that the core has the shape and the dimensions suitable for avoiding welding that part of the parison to be welded when it is present (otherwise it could not subsequently be demoulded). It therefore comprises as it were an excrescence that is inserted between the edges of the mould impressions (and thus prevents their abutment) during the first closure of the mould. It is this “excrescence” that is preferably heated in the abovementioned steps.

In the process according to the invention, it is advantageous for the welded part to be extended (via a weld bead of material accumulated during the pinching of the part to be welded in order to produce the weld) towards the outside of the hollow body, as in the abovementioned application EP 1 190 837. The extension is created near the weld between two elements (edges of the sheets or of the parison) and extends towards the outside in the form of an appendage which includes the barrier layers of each element. This appendage may take various forms. Preferably, its base anchored into the hollow body is of larger cross section than its end. It may be in the form of an excrescence having a cross section (perpendicular to the surface of the tank and to the weld bead) in the form of a tip of a lance where the ends of the barrier layers join up. It may also be in the form of an excrescence whose cross section has a substantially triangular base and terminates, on the external side of the hollow body, in a flattened blade which includes the barrier layers that join up at their ends. This variant is preferred as it makes it possible for the ends of the barrier layers, which are contained in each element to be welded, to be better welded together.

It is therefore particularly advantageous in the process according to the invention for the part to be welded to consist of two edges of one and the same structure or similar structures that have to be welded together and that once said part has been welded, it is extended via a weld bead towards the outside of the hollow body in the form of an appendage, the cross section of which (in a plane perpendicular to the surface of the hollow body and to the weld bead) has a substantially triangular base and terminates, on the outside of the hollow body, in a flattened blade, the barrier layers coming from the edges of the part to be welded being joined to the end of the said flattened blade.

In such an appendage, the distance between the barrier layers at the tip of the blade is preferably less than 50 gm. Furthermore, it is preferable that a length of at least 0.5 mm, preferably at least 1 mm or even up to 4 mm (depending on the intended permeability) the distance between the barrier layers be less than

250 μm, or even less than 200 μm, and preferably less than 150 μm. These parameters (distance between barrier layers and length over which this distance is respected) determine in fact the leak path.

The present invention also relates to apparatus suitable for implementing the process described above. This apparatus preferably consists of a mould comprising at least two impressions having, respectively, an external surface and an internal surface that includes a weld zone, these impressions being provided with a cooling device over their entire internal surface with the exception of the weld zone, which is provided with a heating device.

The aforementioned cooling and heating devices may be of any known type (circulation of a coolant or heat-transfer agent; heating cartridge or wire, etc.). The cooling is advantageously performed by the circulation of a coolant (water). The heating is advantageously performed by means of a heating wire (resistor).

As mentioned above, the mould may also include a core, which is then also preferably provided with a heatable weld zone.

These cooling and heating zones are advantageously provided with a thermal control device, such as a thermocouple for example.

For constructing the mould, it is necessary to take into account the expansion of the heated zones relative to the cooled zones. To solve this problem, the mould preferably consists of various assembled blocks with a gap between them. The gap will be of the order of a few tenths of a millimetre (typically from 0.1 to 0.5 mm) so as not to let material enter when the weld zone is cold and so as not to introduce thermal stresses when it is hot. The choice of constituent materials of these various blocks may also contribute to the optimization of the result obtained. In general, these blocks are based on a metal, and preferably based on different metals. Good results have been obtained with aluminium blocks for the cooled bulk of the mould and steel blocks for the heated weld zone. Most particularly preferably, the cooled blocks are based on aluminium and include a circuit for circulating a coolant, and the heated blocks are based on steel and include a heating resistor and a thermocouple.

According to a particularly preferred variant, the mould impressions are provided in the weld zone with a cavity of suitable shape for allowing the barrier layers to come close together at their ends and to allow moulding of a weld bead having a triangular base and an end in the form of a flattened blade, as described above. The length of this cavity and of the appendage that results therefrom is such that the leak path (or permeability between the barrier layers) is long enough to reduce the amount of liquid and/or gas that can pass therein over a given time to a very low value (see above, in the “process” aspects).

Preferably, the welded part in the process according to the invention is extended by an appendage substantially over its entirety. In the case of hollow bodies moulded from two sheets, this amounts to equipping the two impressions with a cavity that extends over their perimeter, the said cavity being thermally regulated independently of the rest of the mould.

Lastly, in a final preferred variant of the invention, which is very suitable in the case of the variant with the abovementioned automatic deflashing, one of the mould impressions is provided with a fastening device (A), for fastening the sprue to its outer surface, and the other impression includes a retaining device (B) for retaining the tank on its inner surface.

The device (A) may consist of a clamp or preferably several clamps placed uniformly around the perimeter of the impression in question. As regards the device (B), this may consist of a retractable insert or preferably several retractable inserts on the internal surface of the other impression. These inserts are “advanced” and placed so as to be in relief relative to the internal surface of the impression during moulding and during opening of the mould, and are retracted from the said surface in order to be able to demould the tank from its impression. Upon opening the mould, as explained above, the sprue will remain attached to one impression and the tank, or the other.

The device according to this variant of the invention preferably includes a core, the shape or the structure of which is such that it can fold back the edges of the parison over the outer surface of the impressions. It also preferably includes a gripping tool (robot arm or manipulator) for separately removing the sprue and the tank from the mould after it has been opened.

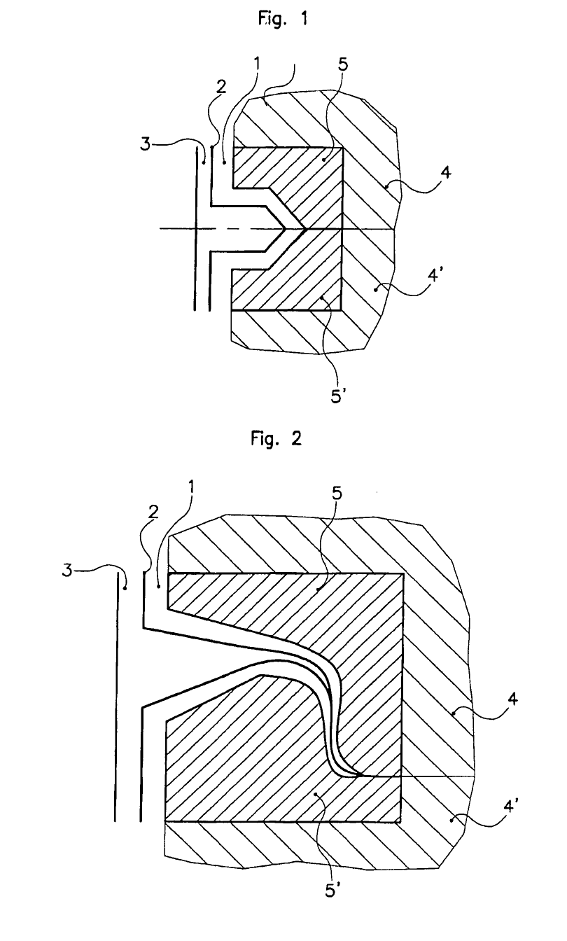

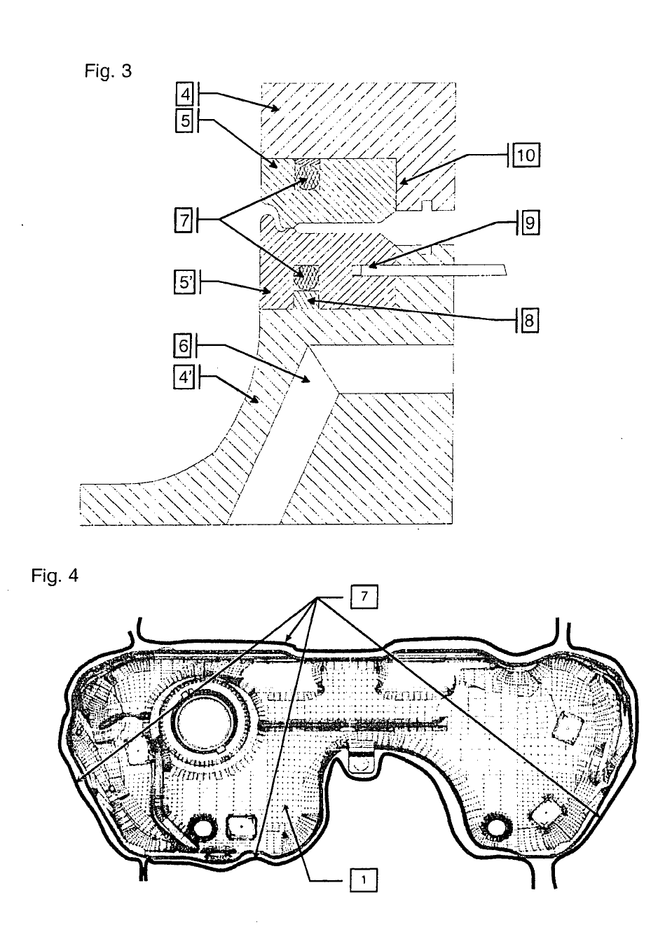

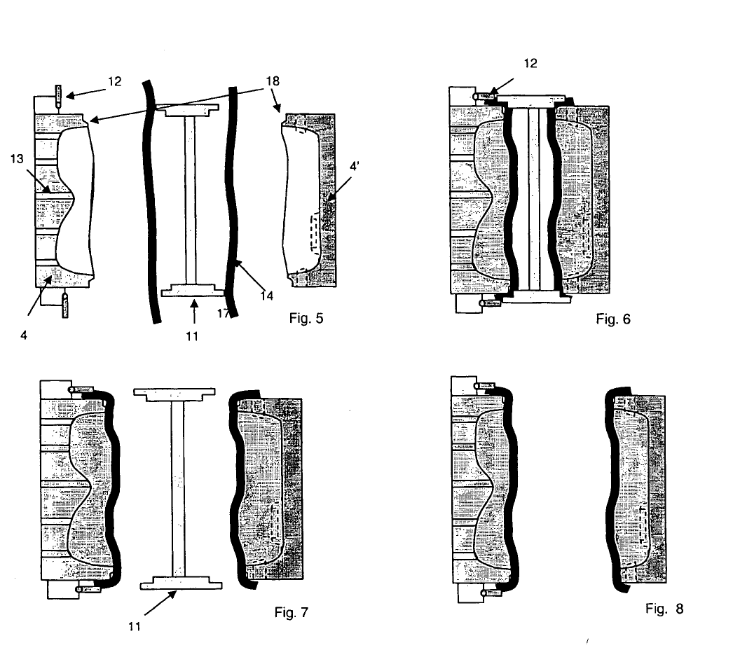

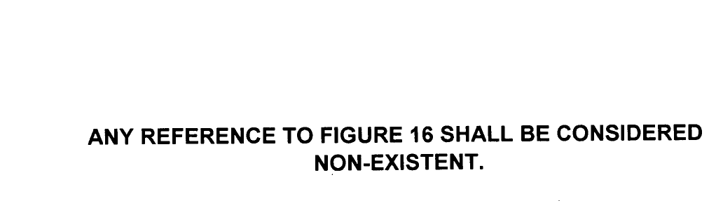

The present invention will be illustrated non-limitingly by FIGS. 1 to 15. FIGS. 1 and 2 illustrate the geometry of a weld bead according to certain variants of the invention. FIGS. 3 and 4 illustrate the geometry of a mould in one particular variant of the invention. FIGS. 5 to 16 illustrate the successive steps of an embodiment of the process according to the invention. In these figures, identical numbers denote identical elements.

FIGS. 1 and 2 illustrate the wall of a fuel tank (1) that includes an EVOH-based barrier layer (2) between two HDPE layers (3). This tank is in a mould comprising two impressions (4, 4′) provided with a cavity of given shape in the weld zone. This shape is that of the tip of a lance in FIG. 1 and of an appendage having a cross section with a triangular base terminating in a flattened blade in FIG. 2. The zone (5, 5′) adjacent to this cavity is provided with a heating device, whereas the remaining part of the impressions is provided with a cooling device.

FIG. 3 shows a detail of the plane of a mould similar to that illustrated in FIG. 2. The mould again has the two impressions (4, 4′), which are made of aluminium, with their respective welding/heating zones (5, 5′), which are made of steel. This figure also shows that the impression (4) is provided with a cooling circuit (6) and that the heating zones (5, 5′) include a resistor (7) fastened by means of an aluminium plug (8). The heating zone (5, 5′) is provided with a thermocouple (9). A gap (10) of the order of a tenth of a millimetre has been provided between the steel blocks and the aluminium blocks when they are fitted together so as to compensate for the relative expansions of these blocks.

FIG. 4 is a theoretical diagram illustrating a cross section of the tank (1) through its parting line and showing that, during moulding of the tank, the weld zone was equipped with four different resistors (7), each coupled to a thermocouple, so that the temperature in this zone is optimally regulated.

FIGS. 5 to 16 illustrate the successive steps of an embodiment of the process as explained hereunder:

FIG. 5—a parison (14) is extruded and is placed between two impressions (4,4′) of a mould. The impressions (4,4′) are provided with a weld zone (18). A core (11) is inserted inside the parison (14) located in the mould

FIG. 6—the mould is closed a first time and the parison (14) is pressed against the mould impressions (4,4′). Impression (4) is provided with clamps (12) for fastening the peripheral part of the parison (14), ie. the sprue

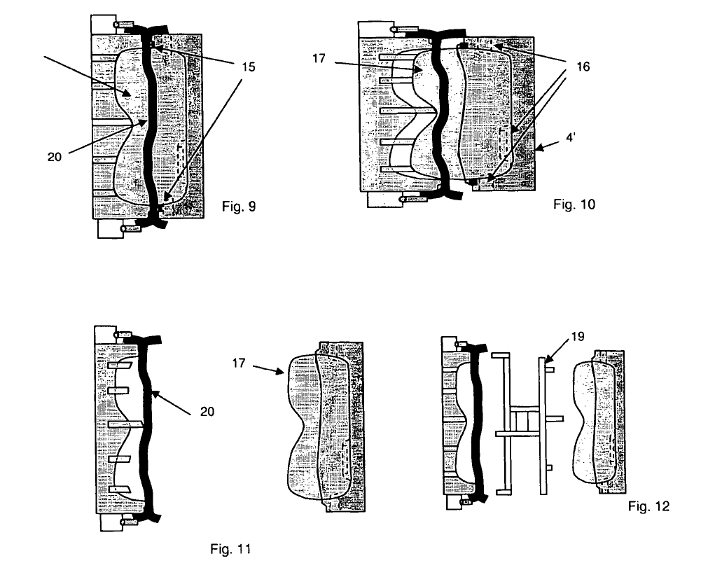

FIGS. 7, 8—the mould is opened and the core (11) is removed

FIG. 9—the mould is closed a second time and a tank (17) is blown while the peripheral part of the tank is welded. The welding region is heated using a device (15). Deflashing of the tank is performed, ie. the sprue is cut from the tank.

FIG. 10—the mould starts opening. Impression (4) is equipped with retractable inserts (13) that act as ejectors that push the blown tank (17) towards the impression (4′) while clamps (12) maintain the cut sprue (ie. scraps) (20) into impression (4). Impression (4′) comprises retaining devices (16) that retain the blown tank (17) in impression (4′)

FIG. 11—after the opening of the mould, the scraps (20) is fixed to the impression (4) and the tank (17) is fixed to the impression (4′)

FIG. 12—a manipulator (19) is inserted between the impression (4,4′) of the mould

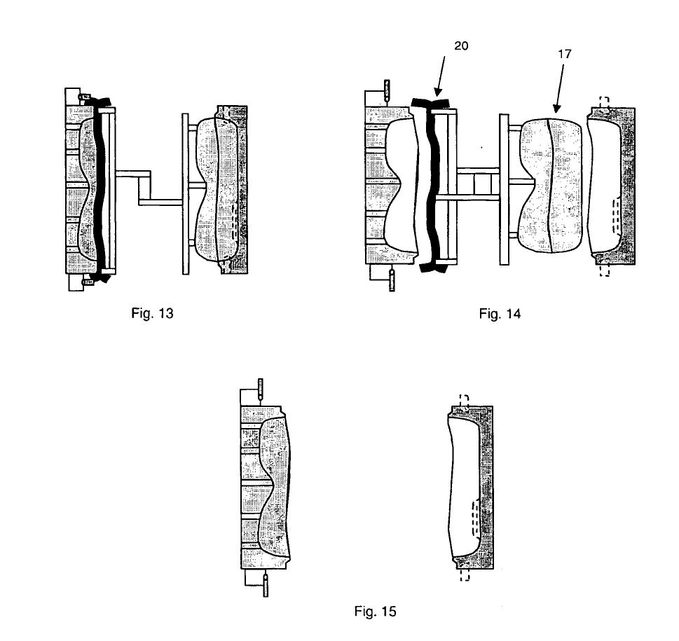

FIG. 13—the manipulator (19) grips either the scraps (20) and the tank (17) and the clamps (12) release the scraps (20)

FIG. 14—the manipulator (19) separately removes the scraps (20) and the tank (17) from the mould impressions (4, 4′)

FIG. 15—the mould is ready for a next production process

1-16. (canceled)

17. A process for production, by molding, of a hollow plastic body with a multilayer structure that includes a liquid barrier layer, the process comprising:
a) inserting a parison including at least one part to be welded into an open mold including at least two impressions that are provided with a weld zone so as to position the part to be welded in the weld zone;
b) closing the mold, juxtaposing its impressions so as to clamp that part of the parison to be welded and to carry out a welding;
c) injecting a pressurized fluid into the mold and/or pulling a vacuum behind the mold impressions to press the parison against the mold impressions and to mold the hollow body; and
d) opening the mold and extracting the hollow body,
wherein, during a) to d), the mold impressions are cooled, exception at the weld zone, which is heated using a heating device at least during a) and b),

18. The process according to claim 17, wherein the hollow body is a fuel tank, the barrier layer is based on EVOH (a partially hydrolysed ethylene/vinyl acetate copolymer), and wherein it is surrounded on both sides by at least one layer based on HDPE (high-density polyethylene).

19. The process according to claim 17, wherein the weld zone is also heated during c) and d), and wherein, before b), the parison is fastened to only one of the two impressions, edges of the parison are folded back outwards over the two impressions, and the edges are fastened to that one of the two impressions that is not fastened to the parison.

20. The process according to claim 17, wherein the impressions are cooled down to a temperature of between 0° C. and 20° C. during a) to d), and wherein the weld zone is heated to a temperature of at least 40° C. during a) and b).

21. The process according to claim 17, further comprising, between a) and b):
a1) inserting a core inside the parison located in the mold;
a2) closing the mold a first time, with the impressions brought back around the core;
a3) pressing the parison against the mold impressions by blowing through the core and/or by vacuum suction behind the impressions;
a4) providing the parison with functional elements by the core; and
a5) opening the mold and removing the core.

22. The process according to claim 17, wherein the parison includes two sheets to be thermoformed, and the process further comprising, before b):
a1) fastening the two sheets via their perimeters to two frames;
a2) placing the two frames on the mold impressions so as to obtain a sealed zone between the sheets and the mold impressions;
a3) pressing the sheets against the mold impressions by vacuum suction behind the impressions;
a4) optionally providing the parison with functional elements by a robot arm; and
a5) removing the frames.

23. The process according to claim 21, wherein the weld zone is heated both in its external part at the impressions and in its internal part in the core or frames while the mold is closed on the core, and wherein the frames are in contact with the parison.

24. The process according to claim 17, wherein the part to be welded includes two edges of one and a same structure or of similar structures, and wherein, once the part has been welded, the part is extended via a weld bead towards an outside of the hollow body in a for of an appendage, a cross section of which in a plane perpendicular to the surface of the hollow body and to the weld bead has a substantially triangular base and terminates, on the outside of the hollow body, in a flattened blade, the barrier layers coming from the edges of the part to be welded being joined to the end of the the flattened blade,

25. An apparatus for implementing a process according to claim 17, the apparatus comprising a mold including at least two impressions having, respectively, an external surface and an internal surface that includes a weld zone, the impressions being provided with a cooling device over their entire internal surface with the exception of the weld zone, which is provided with a heating device.

26. The apparatus according to claim 25, wherein the mold includes separate blocks for the heated zones and the cooled zones, and wherein the blocks are assembled with a gap of an order of a few tenths of a millimeter between them.

27. The apparatus according to claim 26, wherein the cooled blocks are based on aluminium and include a circuit for circulating a coolant, and wherein the heated blocks are based on steel and include a heating resistor and a thermocouple.

28. The apparatus according to claim 25, wherein the mold impressions include a cavity in the weld zone.

29. The apparatus according to claim 25, wherein one of the mold impressions includes a fastening device, for fastening the edges of the parison to its outer surface, and wherein the other impression includes a retaining device for retaining the tank on its inner surface.

30. The apparatus according to claim 29, wherein the fastening device includes plural clamps placed uniformly around the perimeter of the impression in question, and the retaining device includes plural retractable inserts on the internal surface of the other impression.

31. The apparatus according to claim 28, further comprising a core, a shape or structure of which is such that the core can fold back edges of the parison over an outer surface of the impressions.

32. The apparatus according to claim 28, further comprising a gripping tool configured to separately grip the edges of the parison and the tank after the mold has been opened.
